(19) United States
(12) Patent Application Publication
(10) Pub. No.: US 2017/0283671 A1
(43) Pub. Date: Oct. 5, 2017

(54) 1K High Temperature Debondable Adhesive

(71) Applicants: Henkel AG & Co. KGaA, Duesseldorf (DE); Henkel IP & Holding GmbH, Duesseldorf (DE)

(72) Inventors: Stephen Hynes, Dublin (IE); Chunyu Sun, Shanghai (CN); Jiangbo Ouyang, Wallingford, CT (US); JinQian Chen, Shanghai (CN)

(21) Appl. No.: 15/629,804

(22) Filed: Jun. 22, 2017

Related U.S. Application Data
(63) Continuation of application No. PCT/CN2015/096670, filed on Dec. 8, 2015.

(30) Foreign Application Priority Data
Dec. 23, 2014 (CN) PCT/CN2014/094613

(51) Int. Cl. C09J 183/14; C09J 5/06; B32B 37/12

(52) U.S. Cl. CPC C09J 183/14; B32B 37/12; C09J 5/06; B32B 2037/1253; C09J 2205/302; C09J 2205/31; C09J 2483/00

(57) ABSTRACT

The present disclosure provides 1k high temperature debondable adhesives for use in the temporary attachment of one substrate to another substrate. The adhesives composition comprising(a) 1,3,5,7-tetravinyl-1,3,5,7-tetramethylcyclotetrasiloxane, or the hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups, or a mixture of a hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups and a hydrosilation reaction product of the reaction between the vinyl groups on vinyl polysiloxane and the terminal Si—H hydrogens on a silane or siloxane having terminal Si—H groups, and (b) mercapto-crosslinker. The adhesive composition is cured by UVNis/LED or thermal or combined and is cured faster requiring lower energy. The present disclosure also provides assemblies including such an adhesive and methods of using the adhesives.

### TECHNICAL FIELD

The present invention relates to 1k (one component in terms of package) temporary adhesives for use in high temperature applications, and particularly relates to adhesives for temporary attachment of one substrate to another substrate.

### BACKGROUND ART

Within a number of industries, there is growing interest in the use of flexible and/or very thin substrates, for example, stainless steel, silicon wafers, glass, ceramic, polyimide and polyester films. Flexible and very thin substrates are too fragile to be handled freestanding in downstream manufacturing conditions, and must be supported on a suitable carrier to survive. After the fabrication processes are done, the substrate must be removable from the carrier undamaged, preferably at ambient temperature.

In the electronics industry, as one example, imaging displays, sensors, photovoltaics and RFIDs, increasingly require thin and/or flexible substrates for display applications for cell phones, personal digital assistants, iPads, or TVs. An exemplary substrate is a very thin (100 μm) glass packed with functionalities. The glass is processed at 300 to 500° C. to deposit thin film transistors (TFT) or at 150-400° C. to deposit indium tin oxide (ITO) as a transparent conductor. Due to the fragility of the glass and the harsh process conditions, this glass must be reinforced or protected by bonding to a more stable substrate during fabrication. Also in the piece-type approach to touch sensor manufacture, the touch sensor glasses are pre-cut and bound to a carrier before deposition processes like those described above. Other industries such as silicon wafer manufacturing also require bonding to a carrier substrate to protect increasingly thin silicon wafers during the back grinding process, followed by subsequent clean release.

Uses such as those described above require a high temperature stable adhesive that is easily and cleanly debondable, that permits temporary bonding at high processing temperatures, and that does not compromise handling or performance of the substrates. This is an object particularly within the electronics industry. Development of such adhesives would allow existing fabrication methods, such as for semiconductors, active matrix thin film transistors, touch membranes, or photovoltaics, to use the currently installed base of manufacturing tools and machines. However, most currently available temporary adhesives are not thermally stable at the maximum processing of the manufacturing steps, which can be as high as 400° C.

Adhesives suitable for high temperature temporary bonding applications, which can later be removed at room temperature without causing damage to the target component, would therefore advance the use of thinner or more flexible substrates across various industries.

High temperature debondable adhesives have 2k (two components in terms of packages). 2k system needs to be mixed with further additives to prepare a proper working product prior to or in the process of application. This brings compromise in the applicability and manageability due to short working times, long curing times, and especially short shelf-life time after open of container. Therefore, 1k system is developed to facilitate the process of application, shorten the curing time and extend the work life or pot life compared with 2k system.

Current 1k composition is fixtured by high power light source and the curing time is not fast enough, furthermore the cure system is unsuitable for low energy LED light sources and furthermore, in the debonding test current 1k adhesive composition sticks to surfaces of both substrates after debond. This necessitates cleaning with solvent to remove the residue

Therefore, there is still a need to develop a new 1k adhesive composition that could solve these problems, while at the same time meet requirements of other performances, such as thermal stability and work life or pot life.

### SUMMARY OF THE INVENTION

The present invention relates to a 1k high temperature debondable adhesive composition comprising
(a) 1,3,5,7-tetravinyl-1,3,5,7-tetramethylcyclotetrasiloxane, or the hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups, or a mixture of a hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups and a hydrosilation reaction product of the reaction between the vinyl groups on vinyl polysiloxane and the terminal Si—H hydrogens on a silane or siloxane having terminal Si—H groups, and

(b) mercapto-crosslinker.

The present invention also relates to an assembly of a substrate and a carrier comprising preferably cured 1K high temperature debondable adhesive composition according to the present invention disposed between the substrate and the carrier.

The present invention encompasses a method for bonding a substrate to a carrier comprising steps of:
providing a substrate and a carrier; disposing a 1k high temperature debondable adhesive composition according to
the present invention on the substrate and/or the carrier;
contacting the substrate and carrier so that the debondable adhesive composition is disposed between the carrier and the substrate, forming an assembly; and
radically curing the debondable adhesive by heating the assembly, or exposing the assembly to radiation, or exposing the assembly to radiation followed by heating.

The present invention further encompasses a method for debonding a substrate from a carrier comprising steps of:
providing a substrate and a carrier;
disposing a 1k high temperature debondable adhesive composition according to the present invention on the substrate and/or the carrier;
contacting the substrate and carrier so that the debondable adhesive composition is disposed between the carrier and the substrate, forming an assembly;
radically curing the debondable adhesive by heating the assembly, or exposing the assembly to radiation, or exposing the assembly to radiation followed by heating; and
mechanically separating the substrate and the carrier, optionally after allowing the assembly to come to ambient temperature and/or one or more steps of processing the substrate.

Finally, the present invention includes the use of the composition according to the present invention as an adhesive, preferably for bonding a substrate and a carrier.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

“Two or more”, as used herein, relates to at least two and comprises 2, 3, 4, 5, 6, 7, 8, 9 or more of the referenced species.

As used within this specification and the claims, “substrate” refers to the target component for the fabrication processes, and “carrier” refers to the support structure for the “substrate”.

The present invention relates to a 1k high temperature debondable adhesive composition comprising (a) 1,3,5,7-tetravinyl-1,3,5,7-tetrannethylcyclotetrasiloxane, or the hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups, or a mixture of a hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups and a hydrosilation reaction product of the reaction between the vinyl groups on vinyl polysiloxane and the terminal Si—H hydrogens on a silane or siloxane having terminal Si—H groups and (b) mercapto-crosslinker.

The partial hydrosilylation reaction product of the reaction between 1,3,5,7-tetravinyl-1,3,5,7-tetramethyl-cyclotetrasiloxane and a silane or siloxane having terminal Si—H hydrogens or between 1,3,5,7-tetramethyl-cyclotetrasiloxane, vinyl polysiloxane and a silane or siloxane having terminal Si—H hydrogens will be referred to herein as a vinylcarbosiloxane or VCS resin or VCSR.

Generally, the term “partial hydrosilylation reaction product”, as used herein, refers to products of the hydrosilylation reaction between 1,3,5,7-tetravinyl-1,3,5,7-tetramethylcyclotetrasiloxane and the terminal Si—H hydrogens on a silane or siloxane or between 1,3,5,7-tetramethyl-cyclotetrasiloxane, vinyl polysiloxane and a silane or siloxane having terminal Si—H hydrogens having terminal Si—H hydrogens, wherein the reaction product retains at least one unreacted vinyl group. The at least one unreacted vinyl group serves as a cross-linking moiety in the subsequent curing reaction (by radical polymerization).

In various embodiments, VCSR has a molecular weight Mw of up to 200000 g/mol, preferably from 1000 to 150000 g/mol. The molecular weight Mw can be determined by gel permeation chromatography (GPC) according to DIN 55672-1:2007-08 using THF as eluent.

As one embodiment, 1,3,5,7-tetravinyl-1,3,5,7-tetramethylcyclo tetrasiloxane reacts with mercapto-crosslinker to obtain 1k high temperature debondable adhesives.

As another embodiment, VCSR reacts with mercapto-crosslinker to obtain 1k high temperature debondable adhesives and the VCSR used here is formed by partial hydrosilylation reaction of 1,3,5,7-tetravinyl-1,3,5,7-tetramethylcyclo tetrasiloxane, having the structure:

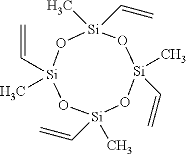

with suitable silanes or siloxanes, having at least two terminal Si—H hydrogens for reacting with the 1,3,5,7-tetravinyl-1,3,5,7-tetrarnethylcyclotetrasiloxane, including those having the structures:

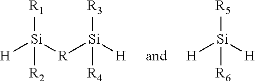

wherein R is selected from the group consisting of a C₁ to C₁₀ alkyl group, an aryl group, for example a C₆ to C₁₀ aryl group, an oxygen, —(O—SiMe2)ₙ—O—, —(O—SiAr₂)ₙ—O—, —(O—SiMeAr)ₙ—O—, and a combination of any of these groups, in which n is an integer of at least 1, Me is a methyl group, and Ar is an aryl group, for example a C₆ to C₁₀ aryl group; and wherein each of R¹, R², R³, R⁴, R⁵, and R⁶, independently is a C₁ to C₁₀ alkyl group or an aryl group, for example a C₆ to C₁₀ aryl group. Preferred for R¹, R², R³, R⁴, R⁵, and R⁶ are C₁ to C₁₀ alkyl groups, in particular C₁ to C₄ alkyl groups, such as methyl or ethyl, or phenyl.

As a further embodiment, VCSR reacts with mercapto-crosslinker to obtain 1k high temperature debondable adhesives and the VCSR used here is formed by partial hydrosilylation reaction of 1,3,5,7-tetravinyl-1,3,5,7-tetrannethylcyclo tetrasiloxane, having the structure:

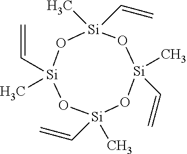

and,
vinyl polysiloxane having structure:

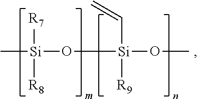

wherein R⁷, R⁸ and R⁹ are independently selected from the group consisting of C₁ to C₁₀ alkyl group or aryl group, and m, n denote positive integers, with suitable silanes or siloxanes, having at least two terminal Si—H hydrogens for reacting with the 1,3,5,7-tetravinyl-1,3,5,7-tetrannethylcyclotetrasiloxane, including those having the structures:

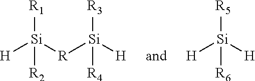

wherein R is selected from the group consisting of a C₁ to C₁₀ alkyl group, an aryl group, for example a C₆ to C₁₀ aryl group, an oxygen, —(O—SiMe₂)ₙ—O—, —(O—SiAr₂)ₙ—O—, —(O—SiMeAr)ₙ—O—, and a combination of any of these groups, in which n is an integer of at least 1, Me is a methyl group, and Ar is an aryl group, for example a C₆ to C₁₀ aryl group; and wherein each of R¹, R², R³, R⁴, R⁵, and R⁶, independently is a C₁ to C₁₀ alkyl group or an aryl group, for example a C₆ to C₁₀ aryl group. Preferred for R¹, R², R³, R⁴, R⁵, and R⁶ are C₁ to C₁₀ alkyl groups, in particular C₁ to C₄ alkyl groups, such as methyl or ethyl, or phenyl.

Exemplary vinyl polysiloxane include copolymer of methylvinylsiloxane and dimethylsiloxane, copolymer of methylvinylsiloxane and diethylsiloxane, copolymer of methylvinylsiloxane and methylethylsiloxane, copolymer of ethylvinylsiloxane and dimethylsiloxane, copolymer of ethylvinylsiloxane and diethylsiloxane, copolymer of ethylvinylsiloxane and methylethylsiloxane, copolymer of propylvinylsiloxane and dimethylsiloxane, copolymer of propylvinylsiloxane and diethylsiloxane, propylvinylsiloxane and methylethylsiloxane, copolymer of phenylvinylsiloxane and dimethylsiloxane, copolymer of phenylvinylsiloxane and diethylsiloxane, copolymer of phenylvinylsiloxane and methylethylsiloxane. The molar ratio of block of vinylsiloxane in above-list copolymers is from 0.3 to 13 and preferably from 0.8 to 11.

Exemplary silanes or siloxanes include polyalkylsilanes and polyalkyl-siloxanes in which the alkyl groups on the silicon atoms are C₁ to C₁₀ alkyl groups. In various embodiments, the silanes and siloxanes include polydialkylsiloxane, such as polydimethylsiloxane, polyalkylaryl siloxane, such as polymethylphenyl siloxane, tetraalkyldisiloxane, such as tetramethylsiloxane, and polydiarylsiloxanes. These compounds are commercially available from Gelest.

Preferred VCSR reaction products are those having the following idealized structures, in which the molecular weight is weight-averaged molecular weight. In various embodiments, the alkyl groups on the silicon atoms of the VCSR reaction products include C₁ to C₁₀ alkyl groups. In the following idealized structures, methyl groups are depicted in the silane/siloxane moiety, but it should be understood that other C₁ to C₁₀ alkyl groups can be substituted.

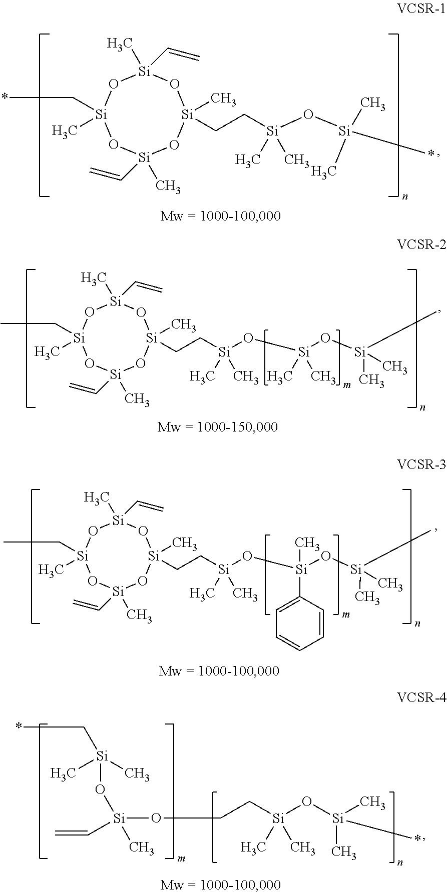

The debondable adhesive composition further comprises a mercapto-crosslinker selected from the group consisting of hydrogen sulfide, tricarballylic mercaptan, isopentyl tetramercaptan, m-triethanethiol benzene, p-diethanethiol benzene, isopentyl tetraacetatemercaptan and mercapto-polysiloxane with structure of:

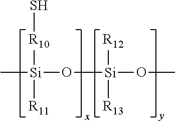

wherein R¹⁰, R¹¹, R¹², R¹³ are independently selected from the group consisting of C₁ to C₁₀ alkyl group or aryl group, x denotes integer more than 1, y denotes positive integer or 0.

Preferably, the mercapto-crosslinker is mercapto-polysiloxane with structure of:

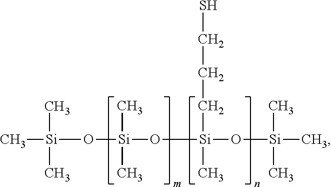

wherein, m and n denotes positive integer numbers. The molecular weight Mw of said mercapto-polysiloxane is from 2000 to 20000 g/mol and preferably from 4000 to 8000 g/mol. The molecular weight Mw can be determined by gel permeation chromatography (GPC) according to DIN 55672-1:2007-08 using THF as eluent.

The mercapto cross-linker is preferred because, thiolene reaction it is involved can be more easily initiated by lower energy UV e.g. LED light source. In addition, an acrylate and the resulting sulfide bond seems more thermally stable than an acrylate polymer.

Optionally, the debondable adhesive composition may further comprise a radical initiator as a catalyst for curing of the VCSR by radical polymerization or cross-linking of the vinyl groups.

Suitable radical initiators are well known to those skilled in the art. For example, the radical initiator may be selected from the group consisting of a-hydroxy ketones, benzophenones, and phenyl glyoxylic acids. Also suitable are all types of acyl-phosphine oxide and bis-acyl-phosphine oxide generally known in the art, and further dicumene peroxide, cumene hydroperoxide, and 2-hydroxy-2-methyl-1-phenyl propan-1-one without limitation.

A preferred radical initiator is dicumene peroxide. Preferred photoinitiators include those sold under the tradenames Darocure® 1173 and Irgacure® 184 (1-Hydroxy-cyclohexyl-α-Hydroxyketone) or 2100 (monoacylphosphine oxide (MAPO) and bisacylphosphine oxide (BAPO)).

Optionally, the debondable adhesive composition may further comprise a filler. As a preferred example suitable filler is fumed silica.

In various embodiments, the compositions comprise the VCSR from 50 to 95% by weight of the total weight of the composition, preferably from 60 to 95% of, and the mercapto-crosslinker from 5 to 50% by weight of the total weight of the composition, preferably from 5 to 40%.

When the radical initiator is present, the composition comprises radical initiator from 0.1 to 5% by weight of the total weight of the composition and preferably from 0.5 to 1.5 %.

When the filler is present, the composition comprises filler from 0.5 to 40% by weight of the total weight of the composition, and preferably from 2.5 to 10%.

The adhesive composition according to the present invention maintains its adhesion properties at temperatures of 300° C. or greater, up to 450° C.

The adhesive composition according to the present invention is mechanically debondable at room temperature at a force of about 0.1 to 5 N/25mm, preferably at a force of 0.2 to 1.5 N/25mm.

Typical curing conditions include exposure to UVNis/LED radiation and/or heat with temperatures less than 200° C.

The energy input is preferably in the range of 2000-20000 mJ/cm², preferably 2000-4000 mJ/cm².

The debondable adhesive composition according to the present invention is cured in less than 45s, preferably less than 35s, and more preferably less than 25s under the afore-mentioned curing conditions.

UV curing time is calculated according to fixture time and fixture time is measured as follows:
take two pieces of glass with dimension of 76mm*26mm*1mm and a light shield; map out a small area on the first piece of glass for UV irradiance;
apply a drop of debondable adhesive composition according to the present invention onto said area;
cover said area by the second piece of glass onto the first piece of glass, however, the second piece of glass is not overlapped with the first one but has circumvolved for an angle between 30° to 90° ; and
irradiate said area by UVALOC 1000 with MPMA bulb at 500W for 10s, 30s, 2min etc. and when each specified time arrives, check by hand whether the fixture of two pieces of glass is complete.

The fixture time is transferred to UV curing time by below relationship:
if fixture time is less than 10s, curing time interval is 5s;
if fixture time is more than 10s, but less than 30s, curing time interval is 10s;
if fixture time is more than 30s, but less than 2 min, curing time interval is 15s;
if fixture time is more than 2 min, but less than 3.5 min, curing time interval is 20s;
if fixture time is more than 3.5 min, but less than 5 min, curing time interval is 30s;
if fixture time is more than 5 min, but less than 10 min, curing time interval is 45s;
if fixture time is more than 10 min, but less than 1 hour, curing time interval is 5 min;
if fixture time is more than 1 hour, curing time interval is 15 minutes.

When three consecutive specimens are fixed at a specified curing time, repeat the test at half of the specified curing time. When three consecutive specimens are not fixed, repeat the test at 1.5 times of the specified curing time.

Curing energy is calculated by multiplying the power of light source for curing by the curing time and divided by the area of adhesive for curing.

The weight loss percentage (%) is used as an index to measure the thermal stability of the composition. The weight loss percentage for the debondable adhesive composition according to the present invention is less than 5%, preferably less than 4.5%, and more preferably less than 4.0% at 350° C.

The weight loss percentage for the debondable adhesive composition according to the present invention is less than 9.5%, preferably less than 7.5%, and more preferably less than 5.5% at 400° C.

The equipment used in the measurement is TA instruments Q50 Thermalgravimetric analyser. Sample weight is 25mg±2mg and the temperature program is rise from room temperature to 550° C. at the speed of 10° C/min. The formula to calculate weight loss is:

% weight loss=[(W−R)/W]*100%
wherein W is original mass of sample specimen, R is the mass of the sample specimen at temperature X. The temperature X is 350° C. or 400° C.

The debond peel force of the 1 k composition according to the present invention is less than 0.5 MPa and preferably less than 0.3 MPa, wherein the debond peel force is measured according to the standard ASTM D2095.

The debondable adhesive sticks only to one of the two substrates after peeled out. The residues of adhesive on surfaces of substrates are also inspected after peeled out.

Work life or pot life of adhesive is a test to monitor the increase of the viscosity for several weeks.

Preferably, the work life or pot life of the debondable adhesive composition according to the present invention is more than 10 days, preferably more than 20 days and more preferably more than 30 days, wherein the viscosity is measured using Brookfield viscometer (dynamic) (RVT DV-II CP#5 2.5 rpm, 25 ° C.).

The present invention also relates to a method for bonding a substrate to a carrier comprising steps of:
providing a substrate and a carrier;
disposing a 1k high temperature debondable adhesive composition according to the present invention on the substrate and/or the carrier;
contacting the substrate and carrier so that the debondable adhesive composition is disposed between the carrier and the substrate, forming an assembly; and
radically curing the debondable adhesive by heating the assembly, or exposing the assembly to radiation, or exposing the assembly to radiation followed by heating.

As described herein, the bonded assembly consisting of carrier, substrate and cured adhesive according to the present invention bonding the carrier to the substrate may be subjected to further processing steps of the substrate.

In various embodiments of the described method of bonding or debonding a substrate from a carrier, the curing by heating the assembly will include applying a temperature or range of temperatures from 100° C. to 175° C. for 1 to 30 minutes. Curing by UV/Vis/LED radiation may be done by exposing the assembly to radiation generated by a UV/Vis/LED lamp, other sources of radiation may also be used within the discretion of the skilled person.

In various embodiments, heating and irradiation can be combined, optionally by applying the heating/irradiation conditions described above. Generally, those skilled in the art can readily determine suitable curing conditions by resorting to general technical knowledge or routine experimentation.

The processing steps may involve for example exposure to temperatures of 300° C. to 500° C. to deposit thin film transistors (TFT) or 150° C. to 400° C. to deposit indium tin oxide (ITO) as a transparent conductor.

In various embodiments, the substrate is a glass substrate or silicon wafer, for example an ultrathin glass or wafer having a thickness of below 0.5 mm, preferably of 100 μm or less.

The bonding of the substrate to the carrier during said processing steps reinforces and protects the substrate.

The carrier can be made of any suitable material, including metal, glass, plastics and ceramics. In other embodiments, the carrier may also be a substrate, for example as defined above.

After said processing steps are completed, the assembly may be cooled and the carrier and the substrate be mechanically separated from each other. In this mechanical separation step, also referred to herein as “debonding”, the separation occurs with adhesive failure at the interface of the substrate and carrier at ambient temperature without damaging the substrate.

The present invention also relates to a method for debonding a substrate from a carrier comprising steps of:
providing a substrate and a carrier;
disposing a 1k high temperature debondable adhesive composition according to the present invention on the substrate and/or the carrier;
contacting the substrate and carrier so that the debondable adhesive composition according to the present invention is disposed between the carrier and the substrate, forming an assembly;
radically curing the debondable adhesive by heating the assembly, or exposing the assembly to radiation, or exposing the assembly to radiation followed by heating; and
mechanically separating the substrate and the carrier, optionally after allowing the assembly to come to ambient temperature and/or one or more steps of processing the substrate.

The present invention further encompasses the use of the compositions described herein as debondable adhesives, in particular for reversibly bonding a substrate and a carrier to each other. The uses may include similar steps as the methods that have been described above.

### EXAMPLES

Generally, it should be understood that all embodiments disclosed herein in relation to the compositions of the invention are equally applicable to the disclosed methods and uses and vice versa.

The composition according to the present invention is prepared by methods known to skilled persons in art. Several important tests e.g. work life/pot life, UV curing time and curing energy, thermal stability and debondable peel force are carried out to compare the inventive 1k composition with current 1k composition. The formulations of inventive 1k composition and current 1k composition and their test results are listed in Tables 1 and 2.

TABLE 1

| | Example 1: | | Comparative Example 2: | |
|---|---|---|---|---|
| | Inventive 1k formulation | | Non-Inventive 1k formulation | |
| For- | Mixture Vinyl | 93.65% | Vinyl | 84.8 wt % |
| mu- | carbosiloxane resins | | carbosiloxane | |
| la- | of which the weight | | resins | |
| tion | ratio of vinyl poly- | | | |
| | siloxane and | | | |
| | 1,3,5,7-tetravinyl- | | | |
| | 1,3,5,7-tetramethyl- | | | |
| | cyclotetrasiloxane | | | |
| | is 1:9 | | | |
| | Mercaptosiloxane | 5% | vinyl siloxane | 9% |
| | (Gelest SMS-042) | | crosslinker (e.g. | |
| | | | Gelest PDV-0535) | |
| | Vinyl siloxane (e.g. | 0.5% | (meth)acrylated | 5.0% |
| | 1,3,5,7-tetravinyl- | | siloxane (e.g. | |
| | 1,3,5,7-tetramethyl- | | Gelest RMS-083) | |
| | cyclosiloxane) | | | |
| | Photoinitiator | 0.5% | Photoinitiator (e.g. | 1.0% |
| | (Irgacure 651) | | Darocure 1173) | |
| | Thermal radical | 0.35% | Thermal radical | 0.2% |
| | initiator | | initiator (e.g. | |
| | (dicumyl peroxide) | | dicumyl peroxide) | |

Work life/pot life is measured according to test method described above.

UV Curing time and curing energy is measured according to test method described above.

The fixture time is transferred to UV curing time by below relationship as described above.

Curing energy is calculated as described above.

Thermal stability of adhesive is carried out according to the method described above.

Debond peel force measured according to the standard ASTM D2095. And the residues of adhesive on surfaces of substrates are also investigated after peeled out.

TABLE 2

| | | Comparative |
|---|---|---|
| | Example 1: | Example 2: |
| | Inventive 1k | Non-Inventive |
| | formulation | 1k formulation |
| UV curing time* | 20 s | 45 s |
| LED curable | Yes | No, still liquid |
| Curing energy | 2000 mJ/cm² | 4500 mJ/cm² |
| Thermal stability** | Weight loss 3.9% at | Weight loss 3.12% at |
| | 30 min at 350° C. | 350° C. |
| | Weight loss 5.41% 1 | Weight loss 7.12% at |
| | hr at 400° C. | 400° C. |
| Complex modulus | 1*10⁵ | 6*10⁵ |
| of polymer after | | |
| full cure | | |
| Adhesive Crack and | No crack, no | No crack, no |
| delamination | delamination | delamination |
| performance after | | |
| thermal baking*** | | |
| Debond peel force | 0.33 MPa | 0.4 MPa |
| Bond failure mode | Adhesive residue on | Adhesive residue |
| | one of two substrates | sticks to both |
| | after debond | substrates |
| Residue removal | Adhesive residue | Adhesive residue |
| after thermal | can be peeled | must be removed |
| baking | from glass | with solvent |
| Work life/pot life | Viscosity increase <10% | Viscosity increase <10% |
| | after 6 months | after 6 month |

*Using a MPMA UV flood chamber e.g. Loctite UVALOC 1000, 500 W, Intensity UVA, ~100 mW/cm²
**Measured by TGA under nitrogen: RT-350 C. hold 30 mins-RT ramp rate 20 C./min or RT-400 C., hold 1 hr-RT, ramp rate 20 C./min.
***Glass to glass laminates (150 micron bond gap) were heated to 250 C. 1 hr then 350 C. 10 mins

As shown in Table 2, compared with current 1k composition, the inventive 1k composition has shorter curing time requiring less curing energy and can be cured with LED single wavelength light sources. Moreover, the thermal stability of the inventive composition is also higher than the current one at 400° C. The debonding peel force is acceptable and another advantage of the inventive composition is the adhesive sticks to only one of the two substrates and is peelable even after thermal baking.

1. A 1k high temperature debondable adhesive composition comprising
(a) 1,3,5,7-tetravinyl-1,3,5,7-tetramethylcyclotetrasiloxane; or the hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups; or a mixture of a hydrosilation reaction product of the reaction between the vinyl groups on 1,3,5,7-tetravinyl-1,3,5,7-tetramethylcyclotetrasiloxane and the terminal Si—H hydrogens on a silane or siloxane having terminal Si—H groups and a hydrosilation reaction product of the reaction between the vinyl groups on vinyl polysiloxane and the terminal Si—H hydrogens on a silane or siloxane having terminal Si—H groups, and
(b) mercapto-crosslinker.

2. The debondable adhesive composition according to claim 1, wherein the silane or siloxane having terminal. Si—H hydrogens has the structure 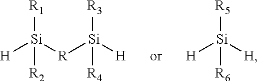
wherein R is selected from the group consisting of a C₁ to C₁₀ alkyl group, an aryl group, an oxygen, —(O—SiMe₂)ₙ—O—, —(O—SiAr₂)ₙ—O—, —(O—SiMeAr)ₙ—O—, and a combination of any of these groups; n is an integer of at least 1; Me is a methyl group; Ar is an aryl group; and each of R¹, R², R³, R⁴, R⁵, and R⁶, is independently selected from a C₁ to C₁₀ alkyl group or an aryl group.

3. The debondable adhesive composition according to claim 2, wherein the silane or siloxane having terminal Si—H hydrogens is selected from the group consisting of polydialkylsiloxane, polyalkylaryl siloxane, tetraalkyldisiloxane and polydiaryl siloxane.

4. The debondable adhesive composition according to claim 1, wherein the siloxane having substituted vinyl group has the structure 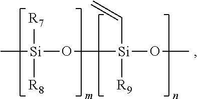
wherein R⁷, R⁸ and R⁹ are each independently selected from the group consisting of C₁ to C₁₀ alkyl group or aryl group, and m, n denote positive integers.

5. The debondable adhesive composition according to claim 4, wherein the vinyl polysiloxane is selected from the group consisting of copolymer of methylvinylsiloxane and dimethylsiloxane; copolymer of methylvinylsiloxane and diethylsiloxane; copolymer of methylvinylsiloxane and methylethylsiloxane;
copolymer of ethylvinylsiloxane and dimethylsiloxane; copolymer of ethylvinylsiloxane and diethylsiloxane; copolymer of ethylvinylsiloxane and methylethylsiloxane; copolymer of propylvinylsiloxane and dimethylsiloxane;
copolymer of propylvinylsiloxane and diethylsiloxane; copolymer of propylvinylsiloxane and methylethylsiloxane; copolymer of phenylvinylsiloxane and dimethylsiloxane; copolymer of phenylvinylsiloxane and diethylsiloxane; copolymer of phenylvinylsiloxane and methylethylsiloxane; and combinations thereof.

6. The debondable adhesive composition according to claim 1, wherein the mercapto-crosslinker is selected from the group consisting of hydrogen sulphide; tricarballylic mercaptan; isopentyl tetramercaptan; m-triethanethiol benzene; p-diethanethiol benzene; isopentyl tetraacetatemercaptan; mercapto-polysiloxane with structure of 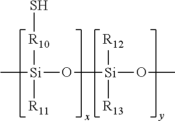
wherein R₁₀, R¹¹, R¹², R¹³ are each independently selected from the group consisting of C₁ to C₁₀ alkyl group or aryl group, x denotes an integer more than 1, y denotes 0 or a positive integer; and combinations thereof.

7. The debondable adhesive composition according to claim 1, wherein the mercapto-crosslinker has the structure 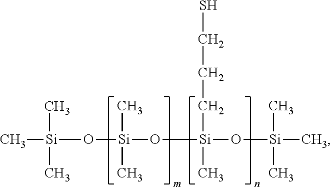
wherein, m and n are each positive integer numbers.

8. The debondable adhesive composition according to claim 1; further comprising a radical curing initiator (c).

9. The debondable adhesive composition according to claim 1, further comprising a radical curing initiator selected from the group consisting of a-hydroxy ketones;
benzophenones; phenyl glyoxylic acids; acyl-phosphine oxides; bis-acyl-phosphine oxides; dicumene peroxide; cumene hydroperoxide; 2-hydroxy-2-methyl-1-phenyl propan-1-one; and combinations thereof.

10. The debondable adhesive composition according to claim 1, further comprising filler (d).

11. The debondable adhesive composition according to claim 1, wherein the (a) reaction product is selected from at least one of the structures:

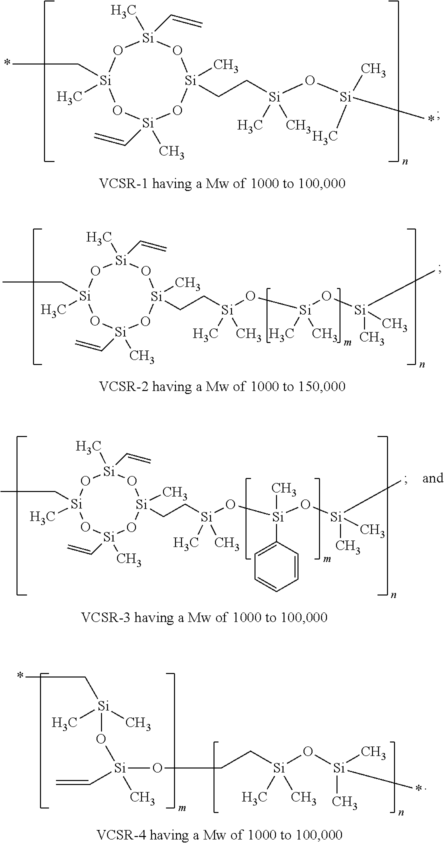

12. The debondable adhesive composition according to claim 1, comprising:
50 to 95 wt. % of the (a) 1,3,5,7-tetravinyl-1₁3,5,7-tetramethylcyclotetrasiloxane; or the hydrosilation reaction product;
5 to 50 wt.% of the (b) mercapto-crosslinker;
optionally 0.1 to 5 wt. % of a radical initiator; and
optionally 0.5 to 40 wt. % of filler; wherein all wt. % are by weight of the total composition.

13. Cured reaction products of the debondable adhesive composition according to claim 1.

14. Cured reaction products of the debondable adhesive composition according to claim 1, wherein the cured reaction products have a thermal stability weight loss of less than 5.5% at 400° C. and a mechanical debond peel force (ASTM D2095) of less than 0.5 MPa.

15. An assembly comprising a substrate and a carrier, including the debondable adhesive composition according to claim 1 disposed between the carrier and the substrate.

16. A method for bonding a substrate to a carrier comprises steps of:
(i) providing a substrate and a carrier;
(ii) disposing the debondable adhesive composition according to claim 1 on the substrate and/or the carrier;
(iii) contacting the substrate and carrier so that the debondable adhesive composition is disposed between the carrier and the substrate, forming an assembly; and
(iv) radically curing the debondable adhesive by heating the assembly, or exposing the assembly to radiation, or exposing the assembly to radiation followed by heating.

17. A method for debonding a substrate from a carrier comprises steps of:
(i) providing a substrate bonded to a carrier by cured reaction products of the debondable adhesive composition according to claim 1; and
(ii) mechanically separating the substrate and the carrier, optionally after allowing the assembly to come to ambient temperature and/or one or more steps of processing the substrate.
